(19) United States
(12) Patent Application Publication
(10) Pub. No.: US 2011/0196566 A1
(43) Pub. Date: Aug. 11, 2011

(54) "Night Ops" vehicle blackout safety system

(76) Inventor: Kenneth Lee Slater, Lodi, CA (US)

(21) Appl. No.: 12/700,921

(22) Filed: Feb. 5, 2010

(51) Int. Cl. G06F 7/00; B60Q 1/00

(52) U.S. Cl. 701/29; 701/45; 340/438

(57) ABSTRACT

The Night Ops vehicle blackout safety system located within the passenger compartment of a vehicle allows the driver to temporarily disengage the brake lights and back up lights of the vehicle. The Night Ops system uses a dash mounted activation button which is illuminated during use to indicate the status of the system. Audible tones are also used from a buzzer within the control unit to alert the driver that the system is in use. A dash mounted control unit uses a light sensing photocell circuit to determine the ambient lighting conditions. The control unit connects to the interrupter module and activation button through a wiring harness. The Night Ops system contains safety features which automatically disengages the system under certain conditions.

### CROSS REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

1. Field of the Invention

This invention is an improved vehicle blackout system designed to temporarily disable the brake lights and back up lights of a vehicle, while incorporating certain safety features to prevent accidental use. Previous blackout systems have been abandoned by most law enforcement agencies due to liability resulting from the lack of safety features. This system is comprised of an activation button, a light sensing control panel, an interrupter module, and a wiring harness. This system is built with several safety features to prevent the brake lights from being disabled or left disabled inadvertently. The light sensing control panel will not allow the Night Ops system to be activated during the daylight. The system automatically disengages once the headlights are turned on. The system automatically disengages after the vehicle has been shut off. The Night Ops system was designed for use in all types of land based law enforcement and military vehicles, and may have practical uses in other fields yet to be determined.

2. Description of the Prior Art

Lighting control devices for altering specific lighting features such as headlights, interior dome light, brake lights, tail lights, back-up lights, dashboard lights, and the control panel lights are located between the lighting switching arrangements of the vehicle such as the headlight switch, or within a lighting control system designed for emergency lights and siren within an emergency vehicle. These devices allow for special lighting features to be added to the conventional lighting features of the vehicle. Some of the devices allow for an override of the special lighting features to allow the lighting features to operate in the conventional manner when desired by the user.

U.S. Pat. No. 4,037,195 issued Jul. 19, 1977, to Jack Edward Wojslawowicz describes a vehicular signal light control system which includes silicon-controlled-rectifiers of the gate-turn-off type to selectively control the current to the running lights.

U.S. Pat. No. 4,249,160 issued Feb. 3, 1981, to Graham R. Chilvers describes a vehicle mounted light activated control system for operating warning lights which includes a light sensor and a comparator. The comparator then triggers a time delay threshold device which switches on the warning lights for ten seconds, and only when the sensed light intensity of an approaching vehicle exceeds a threshold.

U.S. Pat. No. 4,678,925 issued Jul. 7, 1987, to Diethelm Grocke describes a dashboard lighting switch and switch lever for a motor vehicle.

U.S. Pat. No. 4,812,808 issued Mar. 14, 1989, to Larry F. Ulrich describes an electronic control circuit for controlling vehicle lights. An electronic circuitry board which has emergency circuitry to include tail lights with brake lights, front running lights, turn indicator lights with a switch, an emergency switch, and a brake light switch.

U.S. Pat. No. 4,939,503 issued Jul. 3, 1990, to Carl S. Swanson describes a wiring device system for a towed vehicle which couples the signal lights of both vehicles.

U.S. Pat. No. 5,081,565 issued Jan. 14, 1992, to Ali M. Nabha et al., describes a daytime running light system for a vehicle by employing level sensing comparators to effect reduced illumination of the high beam headlamps.

U.S. Pat. No. 5,644,290 issued Jul. 1, 1997, to Michael E. Rhodes describes a blackout control system which works to disable and alter various lighting features within an emergency vehicle which is controlled through an existing emergency light control panel.

U.S. Pat. No. 5,770,999 issued Jun. 23, 1998, to Michael E. Rhodes describes a blackout control system which works to disable and alter various lighting features within an emergency vehicle which is controlled through an existing emergency light control panel.

None of the above inventions and patents, taken either singly or in combination, is seen to describe the instant invention as claimed.

### SUMMARY OF THE INVENTION

The Night Ops System is a vehicle blackout system used for temporarily disabling the brake lights and back up lights of a vehicle. The Night Ops system is unique in that it incorporates several safety features which were not included in previous vehicle blackout systems. Previous systems did not prevent the system from being used in the daylight and did not automatically restore the lighting functions as found in this present invention. Night Ops uses a dash mounted activation button which is illuminated during use to indicate the status of the system. Audible tones are also used from a buzzer within the control unit to alert the driver that the system is in use. The control unit is mounted on top of the dash board and uses a light sensing photocell circuit to determine the ambient lighting conditions. The control unit connects to the interrupter module and activation button through a wiring harness.

The Night Ops system is specifically designed for use in law enforcement and military vehicles to give the officers and military personnel a tactical advantage while responding to incidents or conducting surveillance at night. Other vehicle blackout systems have been abandoned by most law enforcement agencies due to the fact that they lacked safety features as described in this present invention.

### BRIEF DESCRIPTION OF THE DRAWING

FIG. 1A: is the control unit which houses the light sensing photocell circuit and audible buzzer of the present invention.

FIG. 1B: is the interrupter module of the present invention.

FIG. 1C: is the activation button of the present invention.

### DETAILED DESCRIPTION OF INVENTION

The Night Ops system is activated once the driver pushes the activation button. The activation button temporarily disables the brake lights, as long as the photocell circuit does not detect ambient sun light. While the system is in use the activation button becomes illuminated by an integrated LED and provides a series of flashes in combination with a buzzer which is activated within the control unit. The flashes and buzzer act as an indication to the driver that the brake lights and back up lights have been disabled.

The Night Ops system uses additional safety features to prevent the vehicle from being inadvertently driven with the brake lights and back up lights disabled. The system is designed to only operate while the vehicle's headlights and running lights have been turned off. Once the headlights are turned on, the Night Ops system is automatically disabled and the brake lights and back up lights return to normal operating mode. The Night Ops System automatically becomes disabled after the vehicle's engine has been turned off. Furthermore, if the system were to encounter an error of any kind, the control unit is designed to return the vehicle to normal lights on mode.

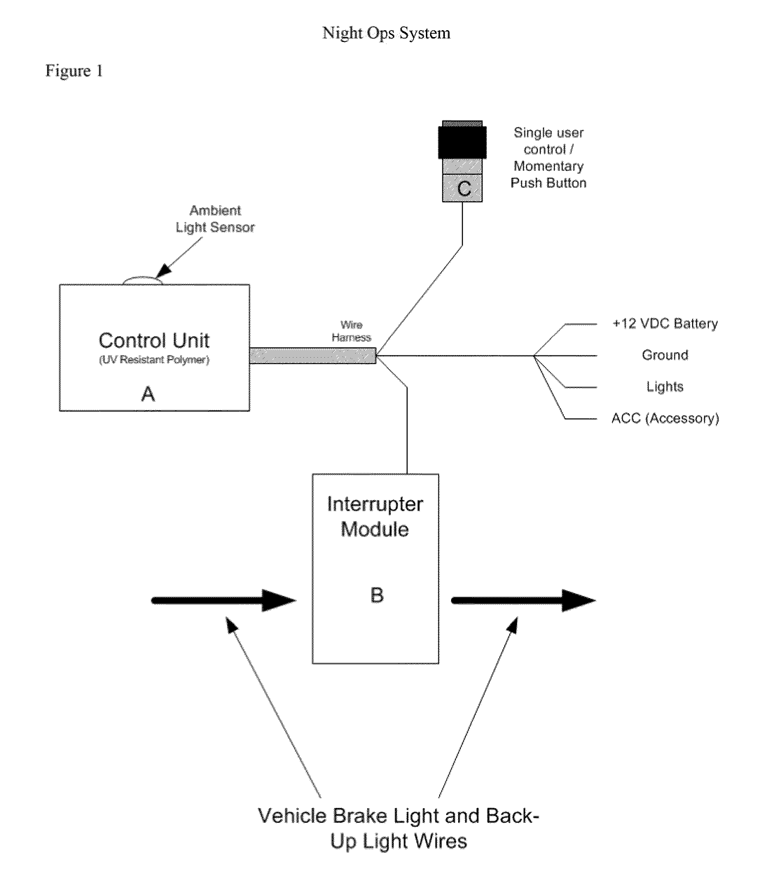

The Night Ops system as illustrated in FIG. 1 is designed to be connected to a vehicle's electrical wiring system. The Control Unit as illustrated in FIG. 1A, is housed in a UV Resistant NORYL Polymer case, designed to mount on the dashboard of the vehicle. The controller is comprised of a microcontroller circuit, voltage conditioning and regulation circuit, photocell light sensing circuit and a relay driven output. The controller monitors the ambient light levels at all times. It has an input from the vehicle's accessory circuit and parking light circuit. The microcontroller monitors light levels from the photocell circuit, the vehicle parking light circuit and accessory circuit. Based on the conditions of these voltage levels, it determines if it will allow the vehicle operator to activate the blackout function. The controller unit connects to the push button through a custom wiring harness, which is made up of 7 conducting wires. The controller unit has a RJ45 8 conductor female jack, which accepts the wiring harness' RJ45 plug.

The interrupter module as illustrated in FIG. 1B, is comprised of ASB Plastic and houses a 4PDT circuit, which when activated will disconnect both left and right brake light circuits; the rear deck brake light and the backup light circuit. It receives input directly through the wiring harness from the controller unit. It has four vehicle light circuit inputs and four vehicle light outputs. Connection is made via a ¼″ spade quick connect.

The user activation button as illustrated in FIG. 1C, is a momentary pushbutton which is backlit by an LED. The LED intensity is controlled by the controller unit. The switch mounts in the dashboard and is used to both activate and deactivate the unit. The switch connects to the controller unit via the wiring harness.

I claim:

1. A vehicle blackout safety control system, which includes features to prevent accidental engagement of or failure to deactivate the system, and is designed for use in a vehicle equipped with brake lights and or back up lights which are operated by the push of the brake pedal or engaging the vehicle in reverse by a shifter.
(a) A blackout safety control system installed in a vehicle comprising of:
a dash mounted blackout control activation and deactivation button containing an LED, which is used to deactivate and reactivate the brake and backup lights;
a control unit containing a microcontroller circuit, a buzzer, and a photocell light sensing circuit, which connects to the blackout control button and interrupter module through a wiring harness;
an interrupter module which connects to the vehicle's lighting system and connects to the control module through the wiring harness.

2. The blackout safety control system according to claim 1, wherein said LED in the control button flashes when the system is activated.

3. The blackout safety control system according to claim 1, wherein said control unit contains a buzzer which sounds to indicate when the system is activated.

4. The blackout safety control system according to claim 1, wherein said interrupter module disengages and reengages the brake and back up lights upon signal from the microcontroller.

5. The blackout safety control system according to claim 1, wherein said control unit contains a photocell light sensing circuit which monitors for ambient light and prevents the system from operating during daylight conditions.

6. The blackout safety control system according to claim 1, wherein said control unit monitors the vehicle's accessory circuit and parking light circuit to prevent the system from being activated when the headlights are on and to auto disable the system in the event that the headlights are turned on from the of position.

6. The blackout safety control system according to claim 1, wherein said control unit disables the system after the vehicle's engine is turned off.

7. The blackout safety control system according to claim 1, wherein said microcontroller has an input from the vehicle's accessory circuit and parking light circuit, which monitors the light levels from the photocell circuit, the vehicle parking light circuit and accessory circuit.
